(19) United States
(12) Patent Application Publication
(10) Pub. No.: US 2009/0000312 A1
(43) Pub. Date: Jan. 1, 2009

(54) METHOD AND APPARATUS FOR COOLING A CONTAINER

(75) Inventors: Douglas M. Smith, Albuquerque, NM (US); Brian Farnworth, Kelowna (CA); Kevin H. Roderick, Albuquerque, NM (US); Peter L. Campbell, Albquerque, NM (US)

Correspondence Address: MARSH, FISCHMANN & BREYFOGLE LLP, 8055 East Tufts Avenue, Suite 450, Denver, CO, 80237, US

(73) Assignee: NANOPORE, INC., Albuquerque, NM (US)

(21) Appl. No.: 12/043,022

(22) Filed: Mar. 5, 2008

Related U.S. Application Data
(60) Provisional application No. 60/892,955, filed on Mar. 5, 2007.

(51) Int. Cl. F25B 9/14; F25D 17/02; F25B 39/02; A23L 3/36

(52) U.S. Cl. 62/6; 62/64; 426/524; 62/515

(57) ABSTRACT

A method and apparatus for the rapid cooling of a container and its contents, such as a beverage container. A heat transfer fluid is thermally contacted with the beverage container, where the heat transfer fluid has a temperature of less than 0° C. The heat transfer fluid can be physically separated from the container, such as by flowing the heat transfer fluid through a heat exchanger that surrounds the container. The cooling parameters can be controlled such that the container and its contents are rapidly cooled without freezing of the contents.

### CROSS-REFERENCE TO RELATED APPLICATIONS

This application claims priority to U.S. Provisional Patent Application Ser. No. 60/892,955 entitled “METHOD AND APPARATUS FOR COOLING A CONTAINER”, filed Mar. 5, 2007, the disclosure of which is incorporated herein by reference in its entirety.

### BACKGROUND OF THE INVENTION

1. Field of the Invention

The present invention relates to a method and apparatus for the rapid cooling of a container and its contents, such as a beverage container. The method and apparatus can be used to rapidly cool a beverage container and its contents from about room temperature to less than about 7° C. so that the cold beverage can be consumed.

2. Description of Related Art

Conventional vending systems for dispensing chilled beverages require continual cooling input and a large cooled volume to store and cool a large number of beverage containers, resulting in a high electrical load. Further, conventional vending machines reject waste heat and during warmer seasons increase the required air conditioning loads in buildings that house the vending machines.

Conventional vending machines are also limited to relatively large insulated boxes that are difficult to transport and that dispense beverage containers at a single temperature. The user has a limited choice of beverage types and also has no control over the temperature of the dispensed beverage container.

For a single case of twenty-four 12 oz (355 ml) aluminum beverage cans, it requires about 248 W·hr of cooling to cool the beverage cans from 30° C. to 7° C. A conventional vending machine also requires approximately 3,600 W·hr of cooling per day of operation just to keep the cabinet cold in a room temperature environment. Even if super-efficient vacuum insulation is employed to line the cabinet, the vending machine will still require about 1,500 W·hr of cooling per day simply to maintain the vending machine temperature. In this regard, for a typical vending machine, the COP (coefficient of performance) is about 1.5, which means that it requires about 1 W·hr of electricity to produce 1.5 W·hr of cooling.

A conventional vending machine includes a vapor compressor cooling system and an insulated cabinet containing a large number of beverage containers. Because of the weight of the compressor and the beverage containers, the cabinet must also have a significant structural component. For a conventional vending machine, over 50% of the machine's volume is taken by the insulation, cooling components and structural components. Because of the surface area to volume ratio necessary to minimize external heat gain, conventional vending machines are relatively large. This can be particularly disadvantageous in confined settings, such as on a ship, a train or a similar setting with limited available space.

Almost all conventional beverage vending machines and domestic refrigerators use vapor compression cooling systems as the cooling source. Although efficiency has dramatically increased over the last 10 years with the use of variable speed DC compressors, vapor compression systems suffer from a COP efficiency decrease as the size of the machine is decreased. Vapor compression systems also tend to be noisy which can be a particular problem in certain environments.

Achieving a significant amount of cooling with a smaller logistical footprint requires a high stored cooling energy density. For example, cooling a 12 oz. beverage can from 25° C. to 4° C. in about ten seconds implies a cooling capacity of about 3,200 W, which is much greater than the capability of conventional refrigerators/vending machines.

One approach is a cooling device disposed within the container, which is activated by the pressure change in the container upon opening. This approach is extremely difficult to implement since it must be completely self-contained (i.e., no heat dissipation to ambient), there must be a minimal loss of container volume that is available for the beverage, a final temperature of about 5° C. is desired regardless of the initial temperature, and the required price points for individual units are very low, on the order of US $0.10 per container unit.

Such a self-contained beverage-cooling device is illustrated in U.S. Pat. No. 6,438,992 by Smith et al., where the device employs water evaporation for cooling. As compared to ice and the other portable cooling options, water evaporation potentially has a much higher energy density. Water's heat of vaporization is about 2,500 J/g, depending upon temperature. Therefore, only about 7 grams (0.2 oz) of water must be vaporized to provide 17.5 kJ (about 4.9 W·hr) to cool 355 ml of beverage by about 6.7° C.

Another approach for point of use beverage cooling is an external approach in which the cooling is provided by a cooling fluid (gas or liquid) that cools the beverage through the container walls, rather than from within the container. In this case, cooling is provided by cold air, such as in a refrigerator or vending machine, or by a cold liquid, such as by putting the beverage container in ice water. The cooling rate depends upon the cooling fluid temperature, the heat transfer coefficient of the cooling fluid and the heat transfer coefficient within the container. For a liquid beverage, the cooling method must typically not over-cool and freeze the beverage inside the container.

Commercial units are available that can cool beverage containers in similar time frames as internal container cooling devices, such as within about 2 to 3 minutes. External cooling devices typically employ a circulating ice water stream sprayed directly on a rotating container to cool the container. These devices have not met wide acceptance because of the requirement for ice, because the containers are wet when cooled, and the relatively long cooling times that are required.

U.S. Pat. No. 3,083,547 by Stevens et al. discloses a method and apparatus for treating the contents of sealed containers or cans, particularly a method and apparatus for agitating and cooling cans to prevent overcooking of the canned product or food.

U.S. Pat. No. 3,316,734 by Crane Jr., discloses an apparatus that is useful to rapidly cool canned liquids such as beer or soft drinks. The apparatus is capable of rapidly rotating a cylindrical container of liquid about its longitudinal axis while the container is cradled in ice.

U.S. Pat. No. 4,139,992 by Fraser discloses a method and apparatus for shell freezing of liquids. The apparatus includes a tank in which sample bottles are rotated on a belt while a cooled heat exchange liquid such as methanol is flowed onto the belt and about the rotating flask. As the bottles revolve, a continuous stream of cooled heat exchange fluid passes under and around each bottle.

U.S. Pat. No. 4,711,099 by Polan et al. discloses a portable chilling device adapted to cool a beverage in a 12 oz. can from about 75° F. (24° C.) to about 45° F. (7° C.) in about 4 minutes. The device utilizes conventional vapor compression to provide cooling.

U.S. Pat. No. 5,505,054 by Loibl et al. discloses a method and device for cooling of a beverage in a can by spraying a cooling fluid onto the can, and rotating the can at sufficient angular velocity to increase the heat transfer rate, but not to cause nucleation of carbon dioxide bubbles when the beverage is carbonated. It is alleged by Loibl et al. that 12 oz. beverage cans can be cooled from room temperature to about 5° C. in about 45 to 50 seconds.

U.S. Pat. No. 6,662,574 by Loibl et al. discloses a method and device for changing the temperature of a liquid in a container. The container is rapidly rotated about its longitudinal axis and ice water is sprayed onto the rotating container to cool the beverage. It is disclosed that the device can also be used to freeze liquids, such as to make ice cream, by using a fluid that can be cooled to less than 0° C. It is also disclosed that other cooling mediums can be used, such as propylene glycol or alcohol.

U.S. Patent Publication No. US 2006/0090480 by Loibl et al. discloses a system for rapidly cooling a liquid in a container within a refrigerator-freezer or freezer. The system includes a housing having a space for receiving a container and a rotator that rotates the container about an axis. While the container is rotating, a sprayer sprays chilled cooling medium on the container in the housing. A reservoir stores the cooling medium when the system is not being used and maintains the cooling medium at a selected temperature. A recirculater, such as a pump, recirculates the cooling medium throughout the system.

U.S. Patent Publication No. US 2006/0185372 by Conde Hinojosa discloses a method and device for the rapid cooling of packaged drinks. An aqueous coolant liquid maintained in a reservoir at a low temperature is applied on the surface of the container, which rotates about its axis. The aqueous coolant liquid can be applied for a time which is calculated from the initial and desired temperatures, the temperatures of the cold liquid and of the rinsing water, and from the temporal coefficient of the packaged beverage.

There remains a need for a method and apparatus for rapidly cooling a container such as a beverage container. It would be advantageous to provide a method and apparatus for cooling a beverage container that are capable of chilling the container and its contents on-demand, i.e., when the user is ready to consume the beverage. The availability of a chilled beverage without using bulk cold storage could significantly reduce distribution costs, reduce the vending machine footprint and reduce energy consumption, and generally provide greater ease of use.

### SUMMARY OF THE INVENTION

The present invention relates to a method and apparatus for cooling a container and its contents, particularly a beverage container. The method and apparatus can cool a beverage container at a rapid rate, while preventing freezing of the beverage within the container when such freezing is not desired. If desired, the method and apparatus can also be used to produce a frozen layer, either on the inside of the container wall, the outside of the container wall or on both sides of the container wall.

According to one embodiment, a method for cooling a container having an outer sidewall is provided. The method includes the steps of cooling a heat transfer fluid to a temperature of less than 0° C., such as not greater than about −20° C., and flowing the heat transfer fluid along the outer sidewall of the container to thermally contact the container and cool the contents of the container. In this embodiment, the heat transfer fluid does not come into direct physical contact with the outer sidewall of the container during the flowing step.

According to another embodiment, a method for rapidly cooling a cylindrical metallic beverage container having a beverage disposed therein is provided. The method can include the steps of cooling a heat transfer fluid to a temperature of not greater than about −20° C., placing the beverage container within a heat exchanger such that the heat exchanger physically contacts an outer sidewall of the beverage container and flowing the heat transfer fluid through the heat exchanger to cool the beverage to a temperature of not less than about 0° C. and not greater than about 7° C.

According to another embodiment, a device for the rapid cooling of a container is provided. The device can include a liquid reservoir adapted to contain a heat transfer fluid therein. The device also includes means for cooling the heat transfer fluid contained within the liquid reservoir to a temperature of less than 0° C., such as a Stirling cooler. A heat exchanger is in fluid communication with the liquid reservoir, the heat exchanger comprising an interior sidewall and flow gaps disposed through the heat exchanger, the flow gaps having a gap width of not greater than about 10 mm, wherein the flow gaps are in fluid communication with the liquid reservoir and wherein the interior sidewall of the heat exchanger is adapted to conform around the container when the container is placed in the device.

### DESCRIPTION OF THE DRAWINGS

FIG. 1 illustrates a plot of beverage temperature as a function of time and total heat transfer rate for aluminum and glass containers when using ice water (0° C.) as a heat transfer liquid according to the prior art.

FIG. 2 schematically illustrates the temperature profiles across a container wall during cooling for three different scenarios of heat transfer limitations.

FIG. 3 illustrates a plot of beverage container cooling rates using low temperature heat transfer fluids compared to the use of ice water.

FIG. 4 illustrates a schematic diagram of an apparatus for cooling a container according to an embodiment of the present invention.

### DESCRIPTION OF THE INVENTION

The present invention is directed to a method and apparatus for the rapid cooling of a container, such as a beverage container. The container can be of any material construction such as metal, glass or plastic container, and in one embodiment the container is a metal container, such as an aluminum container. The container can also have a variety of shapes, and in one embodiment the container is a cylindrical container.

For simplicity, the following description primarily describes the cooling of beverage containers, particularly cylindrical aluminum beverage containers. However the present invention is also applicable to cooling containers of other material construction such as glass or plastic containers, as well as other shapes, and is also applicable to cooling other container contents in addition to beverages.

According to one embodiment, the method and apparatus of the present invention can include the step of thermally contacting a beverage container with a heat transfer fluid to rapidly extract heat from the container and cool the container contents. As used herein unless otherwise specified, thermally contacting means that the heat transfer fluid is placed within sufficient proximity to the container such that heat is transferred from the container to the heat transfer fluid to cool the container and heat the fluid. Also, as used herein unless otherwise specified, cooling the container refers to cooling of both the container and the container contents, such as a beverage, and references to container temperature refer to the temperature of the container contents (e.g., the beverage). In one embodiment, the heat transfer fluid is thermally contacted with the container without coming into direct physical contact with the container. For example, a thin material layer can separate the heat transfer fluid from the container sidewall while maintaining good thermal contact between the fluid and the container.

For heat transfer from an aluminum beverage container to a heat transfer fluid, there are three heat transfer barriers that must be overcome in series, assuming that the boundary between the heat transfer fluid and the membrane is negligible. First is the external boundary layer thermal resistance arising from the boundary between the heat transfer fluid and the external container sidewall(s). Second is the thermal resistance through the aluminum sidewall of the container. Third is the internal boundary layer thermal resistance between the internal container surface and the stagnant liquid beverage on the inside of the container.

The heat transfer can be defined in terms of the heat transfer coefficient (h) in W/m²K and can be thought of as an inverse of thermal resistance. The heat transfer coefficient is given by Equation 1:

$$h = \frac{Δ Q}{A \cdot Δ T \cdot Δ t} \qquad ( 1 )$$

where
Q=heat input or heat lost (J)
A=heat transfer surface area (m²)
ΔT=difference in temperature between the surface and the surrounding fluid (K)
Δt=time period (s)

Thus, the heat transfer coefficient is the proportionality coefficient between the heat flux and the driving force for the flow of heat, namely the temperature difference ΔT.

Since the approximate thickness of the aluminum beverage container sidewall is known and assuming that the internal and external heat transfer coefficients are approximately the same, the average container temperature as a function of time for different heat transfer coefficients using 0° C. ice water as a heat transfer fluid can be calculated. These calculations are plotted in FIG. 1 for 355 ml aluminum and glass beverage containers. As is illustrated in FIG. 1, increasing the overall heat transfer coefficient to 2000 W/m²K enables an aluminum beverage container to be cooled from 30° C. to about 7° C. in about 90 seconds using ice water at 0° C. as a heat transfer fluid.

For an aluminum container, heat transfer restriction through the container wall is negligible. However, for a glass bottle, the increase of about 20× in thickness and the decrease of about 100× in thermal conductivity, as compared to an aluminum can, means that container wall thermal resistance is significant. The time to cool to 7° C. for a glass bottle is increased by a factor of 3× to 4×, which is generally considered unacceptable to consumers of beverages.

The predicted cool-down rate of 90 seconds from 30° C. to about 7° C. for an aluminum beverage container using a heat transfer coefficient of 2000 W/m²K agrees very well with the disclosed results of U.S. Pat. No. 5,505,054 by Loibl et al. However, the time required to reach the desired beverage temperature is still too long for consumers desires, which is generally less than about 30 seconds as indicated by the box labeled “target” in FIG. 1. It is also observed from FIG. 1 that the cooling rate dramatically slows as the beverage temperature approaches 5° C. since the temperature driving force (ΔT) decreases as the beverage temperature approaches the heat transfer fluid temperature of 0° C.

According to one aspect of the present invention, a heat transfer fluid is cooled to a temperature that is less than the freezing point of the beverage, such as less than 0° C. The heat transfer fluid is then thermally contacted with the container to cool the container, such as by flowing the heat transfer fluid along an outer sidewall of the container. It is also preferred that the heat transfer fluid does not come into direct physical contact with the beverage container. For example, the heat transfer fluid can be caused to flow over the outer sidewall(s) of the container to thermally contact and cool the container without physically contacting the container sidewalls by separating the heat transfer fluid and the container sidewall with a thin material layer.

The heat transfer fluid will preferably: 1) have a low freezing point; 2) have a low viscosity; 3) have a high boiling point; 4) be compatible with plastics; and 5) consist of a single component. A low freezing point will enable the heat transfer fluid to remain in the flowable liquid state at very low temperatures thereby providing a strong low temperature driving force (ΔT) for rapid cooling of the container. A relatively low viscosity and compatibility with plastics is desirable for use with a small gap heat exchanger having a low thermal mass, as is described below. A relatively high boiling point will reduce the damage that can occur in the event of a leak of the heat transfer fluid from the apparatus. The use of a heat transfer fluid having a single component will prevent differential freezing of the fluid.

According to one embodiment, the heat transfer fluid is a liquid having a freezing point that is less than 0° C., and more preferably is not greater than about −20° C. and even more preferably is not greater than about −30° C., such as not greater than about −40° C. or even not greater than about −60° C. The heat transfer fluid preferably has a low viscosity that is similar to or lower than the viscosity of water, and preferably is not greater than about 100 centipoise (mPa·s), more preferably is not greater than about 10 centipoise, and even more preferably not greater than about 5 centipoise, when measured at 0° C. The fluid should also maintain such a low viscosity at the reduced temperatures of use in the method and device, such as at about −20° C. or −30° C.

The heat transfer fluid can be aqueous or non-aqueous. Non-aqueous liquids such as alcohols, propylene glycol and the like can be utilized, however it is preferred that the heat transfer fluid is non-flammable. Particularly preferred heat transfer fluids include, but are not limited to, silicone-based fluids such as dimethyl polysiloxane compounds, for example those available from the Dow Chemical Company under the tradenames SYLTHERM XLT and SYLTHERM HF, as well as Dow Corning 200 Fluid, particularly 1.5 CST or 2.0 CST. Silicone-based fluids advantageously maintain a low viscosity at very low temperatures as compared to aqueous-based brine solutions. Also useful are certain non-silicone low temperature heat transfer fluids such as that sold by the Dow Chemical Company under the tradename DOWTHERM J, which is a mixture of isomers of alkylated aromatics. The properties of some of these heat transfer fluids are listed in Table 1.

TABLE 1

| | | | Thermal | |
|---|---|---|---|---|
| | Viscosity | Freezing | Conductivity | Specific Heat |
| Fluid | @ −20° C. | Point | @ −20° C. | @ −20° C. |
| SYLTHERM | 3.1 mPa · s | −111° C. | 0.1192 | 1.688 kJ/kg · k |
| XLT | | | W/m · k | |
| SYLTHERM | 3.88 mPa · s | <−82° C. | 0.1169 | 1.583 kJ/kg · k |
| HF | | | W/m · k | |
| DOWTHERM | 1.80 mPa · s | <−81° C. | 0.1368 | 1.714 kJ/kg · k |
| J | | | W/m · k | |

According to the present invention, the heat transfer fluid is chilled to a fluid temperature that is less than 0° C. In one aspect, the heat transfer fluid can be chilled to not greater than about −10° C., preferably not greater than about −20° C., and even more preferably not greater than about −30° C. The method and apparatus of the present invention advantageously use this extremely low temperature driving force to thermally contact the container and chill the container, but without causing freezing of the beverage within the container, if such freezing is not desired.

The method of the present invention can advantageously use a heat transfer fluid at a temperature below 0° C. to maintain the container wall temperature at about or just above the freezing point of the beverage, such as at about 0° C., during cooling of the beverage container. This can be achieved, for example, by flowing the heat transfer fluid along an outer sidewall of the container to thermally contact the container and cool the container. For a beverage having a freezing point of about 0° C., a container wall temperature significantly above 0° C. slows the cooling rate. However, a container wall temperature below 0° C. (or slightly lower because of supercooling) can lead to undesirable ice formation in or on the container. For aluminum beverage containers, the relationship between the temperatures of the beverage within the container, the container wall and the heat transfer fluid depends upon the relative magnitudes of the heat transfer resistances inside and outside of the container, since for aluminum the heat transfer resistance of the container wall itself is negligible.

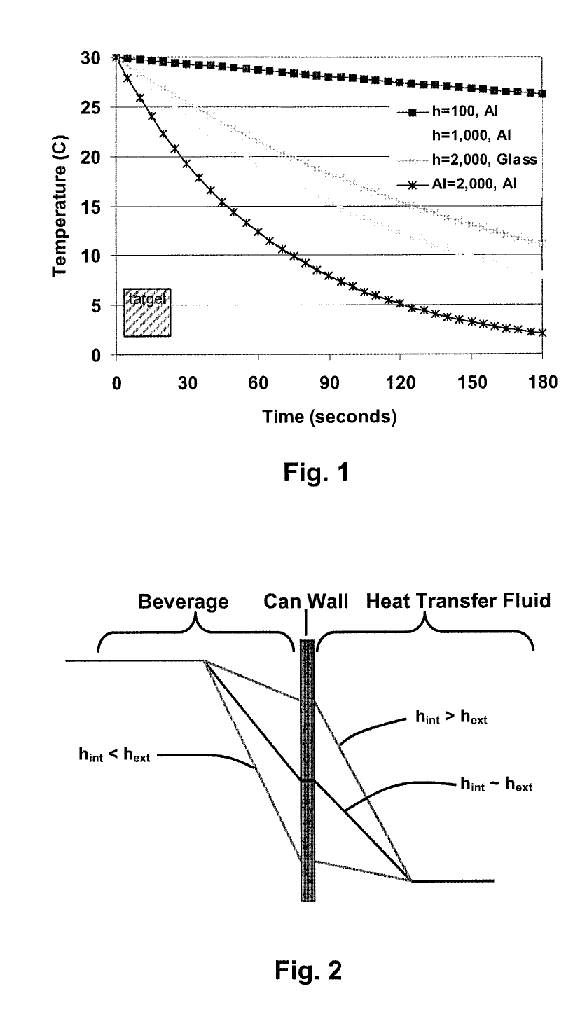

FIG. 2 schematically illustrates the temperature drop for three such scenarios. For the case where the heat transfer coefficient is higher on the inside of the container than on the outside (hᵢₙₜ>hₑₓₜ), the heat transfer fluid temperature can be decreased so that the container wall temperature is maintained about 0° C. For a higher heat transfer coefficient on the outside of the container wall (hᵢₙₜ<hₑₓₜ), most of the thermal resistance is inside the container and the heat transfer fluid temperature can be increased (as compared to hᵢₙₜ>hₑₓₜ) during the cooling process. According to the present invention the relative magnitudes of hₑₓₜ and hᵢₙₜ can be determined for a specified beverage container, and the temperature to which the heat transfer fluid is cooled to yield a container wall temperature of 0° C. for a selected beverage temperature can be determined and utilized to rapidly cool the beverage without freezing of the beverage.

When the container is in thermal contact with the heat transfer fluid, the beverage temperature in the container will decrease with time. This means that the heat transfer fluid temperature will increase during the beverage container cooling period. In accordance with one aspect of the present invention, the cooling of the beverage container can be controlled by using a heat transfer fluid with a pre-selected thermal mass (the product of the fluid mass and heat capacity) relative to the beverage container.

For example, a full 355 ml beverage container has a thermal mass of about 1,380 J/° C., and the desired relative thermal mass of the heat transfer fluid depends upon the ratio of external and internal heat transfer coefficients. If the heat transfer coefficients are similar (hᵢₙₜ≈hₑₓₜ), the thermal mass of the heat transfer fluid is selected to be approximately equal to that of the beverage container at the starting temperature of the heat transfer fluid. By selecting this thermal mass, the heat transfer fluid will naturally warm at a controlled rate as it thermally contacts the beverage container and the beverage container chills, thereby maintaining the container wall temperature at about 0° C. Using SYLTHERM XLT heat transfer fluid as an example, it has a heat capacity of about 1.7 J/g·° C. (Table 1). If 811 grams of this heat transfer fluid are used to cool a 355 ml beverage container (1380 J/° C. divided by 1.7 J/g·° C. equals 811 grams fluid), every 1° C. of cooling in the beverage is matched by a 1° C. of warming in the heat transfer fluid. As a comparison, if a much larger quantity of heat transfer fluid is used such as 8,110 grams, then every 1° C. of beverage cooling would yield only 0.1° C. of heat transfer fluid warming and the wall temperature would decrease during the cooling cycle to below 0° C., thereby freezing the beverage.

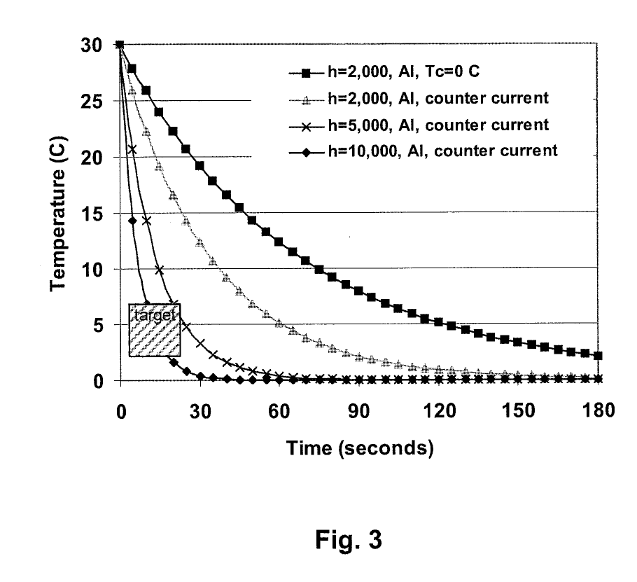

For the case of approximately equal heat transfer resistance and therefore approximately equal thermal mass, the container temperature as a function of time can be calculated. FIG. 3 illustrates the predicted container temperature as a function of time using a heat transfer fluid having an initial temperature of −30° C. Using the same overall heat transfer coefficient as that obtained in U.S. Pat. No. 5,505,054 by Loibl et al. (h=2000 and using ice water at 0° C.), a 2× improvement in cooling rate can be obtained. Accordingly, the container can be cooled from 30° C. to 7° C. in about 45 seconds and to 5° C. in about 60 seconds. Initial heat transfer fluid temperatures below −30° C. can be utilized to yield even higher cooling rates.

Due to the practical limitation that it is typically not desirable to form ice in the beverage container, the cooling rate will always slow as beverage temperature reaches less than about 10° C.

The heat transfer coefficients generated by Loibl et al. are not optimum since they use the same mechanism (can rotation) to generate the internal and external heat transfer coefficients. By rotating at a constant angular speed, internal heat transfer is limited since once the fluid in the container is moving, there is little shear force on the fluid relative to the container wall.

According to one aspect of the present invention, the overall heat transfer rate can be improved by decreasing the internal heat transfer coefficient. This can be achieved by optimizing the movement of the container during cooling to increase the shear force on the fluid relative to the container wall. In one embodiment, the container is rotated during cooling at an angular velocity that is not constant. For example, the container can be rotated in two directions, where the direction of rotation is periodically changed during the cooling process (e.g., by oscillating the container). The angular velocity can also be changed by increasing and/or decreasing the rotational speed during the cooling period. The shear force on the fluid can also be increased by moving the container back and forth along its longitudinal axis in addition to or instead of rotating the container.

With an increase of about 2.5× in the total heat transfer rate to h=5000 W/m²K and using a counter-current heat transfer fluid approach, the time to reach 7° C. can be reduced to about 18 seconds and to reach 5° C. can be reduced to about 25 seconds or less. Another increase in the total heat transfer of 2× to h=10,000 W/m²K can yield a 12 second time to reach 5° C. See FIG. 3.

Due to the extremely low temperature of the heat transfer fluid and the chemical nature of the fluid, it is preferred that the heat transfer fluid does not come into direct physical contact with the container. However, the heat transfer fluid must thermally contact the container such that the flow of heat from the container to the heat transfer fluid is not substantially impeded. In this regard, the container can be placed within a thin material layer to separate the container sidewall from the heat transfer fluid.

It is particularly preferred to utilize a thin-wall heat exchanger to thermally couple the heat transfer fluid to the container without making direct physical contact with the heat transfer fluid. Thus, according to one embodiment of the present invention, a heat exchanger is utilized for the efficient transfer of heat between the heat transfer fluid and the external container wall. The heat exchanger also prevents the heat transfer fluid from coming into direct contact with the beverage container, thereby preventing the container from becoming coated with the heat transfer fluid. Preferably, the heat exchanger includes a plurality of flow gaps, whereby the heat transfer fluid flows from a reservoir, through the flow gaps and returns to the reservoir in a closed-loop counter-current system.

Since heat transfer fluid is not circulated through the heat exchanger when not cooling a beverage (to minimize energy consumption and prevent ice formation from atmospheric moisture), the thermal mass of the heat exchanger should be very low as compared to that of the beverage container so that time and energy is not wasted cooling the heat exchanger during every cooling cycle. In this regard, it is preferred according to one embodiment that the heat exchanger have a thermal mass that is less than about 20%, more preferably less than about 10%, of the thermal mass of the beverage container (e.g., a 355 ml aluminum beverage container). Also, the heat exchanger interior wall thickness should preferably be not greater than about 200 μm, such as not greater than about 100 μm, to ensure good thermal contact between the heat exchange fluid and the container.

The heat exchanger can be fabricated from a material such as a metallic material or a plastic material. Preferably, the heat exchanger is fabricated from a flexible plastic material. Using a flexible plastic material can enable the heat exchanger to tightly conform to a container placed in the heat exchanger. Examples of useful plastic materials include, but are not limited to, polyethylene terephthalate (PET), polyethylene (PE), polypropylene (PP), polyvinyl chloride (PVC), polytetrafluoroethylene (PTFE) and ethylene vinyl alcohol (EVOH). Multi-layer structures of such materials can also be utilized.

According to one particular embodiment, a thin, deformable meso-scale plastic heat exchanger is utilized. The meso-scale heat exchanger includes multiple flow channels through which the heat transfer fluid flows during cooling of the beverage container. The meso-scale heat exchanger preferably has a flow gap width of not greater than about 10 mm, such as from about 0.1 mm to about 10 mm. The heat transfer coefficient increases in inverse proportion to the flow gap width. Thus, smaller gap widths can provide higher cooling efficiency. However, the pressure drop across the heat exchanger also increases with smaller gap width. This leads to a trade-off, where the maximum practical heat transfer rate for liquids is obtained in the region of about 1 mm gap width, such as a gap width of at least about 0.5 mm and not greater than about 3 mm.

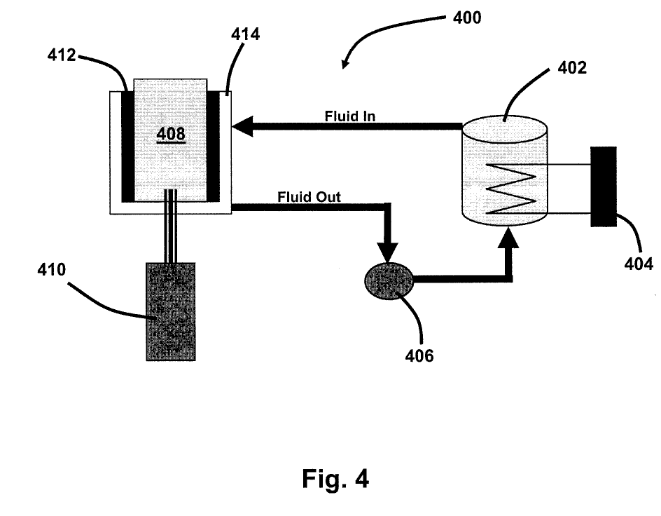

An apparatus that is useful for implementing the method of the present invention is illustrated in FIG. 4. The apparatus 400 includes a reservoir 402 that is adapted to contain a heat transfer fluid. The heat transfer fluid can be chilled by a chiller 404 to a temperature below 0° C., for example to about −20° C. or −30° C., or even lower. The size of the reservoir 402 can be relatively small, and in one embodiment the reservoir has a liquid capacity of not greater than about 2 liters, such as not greater than about 1 liter. The reservoir 402 should be well-insulated to reduce thermal losses through the reservoir wall, and in one embodiment the reservoir is insulated using high efficiency vacuum insulation panels. The chiller 404 can be a chiller that cools the heat transfer fluid by any known mechanism, including a sorption cooling mechanism, a Stirling cycle or thermoelectrics, as well as conventional vapor compression methods.

When a beverage container 408 is placed in the apparatus 400, the heat transfer fluid is displaced from the reservoir 402 and is circulated in thermal contact with the external sidewall surface of the container 408, by flowing through a low thermal mass heat exchanger 412 that is disposed around and in contact with the container sidewall. The heat exchanger 412 can be mounted in a thin, rigid cylinder 414 which has an inner diameter that is slightly larger than the outside diameter of the container 408. The heat exchanger 412 will then expand to fill the gap between the rigid cylinder and the container as the heat transfer fluid flows through the heat exchanger 412.

As the container 408 cools, the heat transfer fluid warms, but remains very cold and is still less than 0° C. A pump 406 transfers the warmed heat transfer fluid back to the reservoir 402. The adaptive, counter-current fluid control advantageously permits the use of the maximum temperature driving force during the entire cooling period, without causing ice formation within the container. Because the size of the reservoir 402 can be relatively small and by employing high performance insulation, the steady state heat loss from the reservoir can be very low despite the extremely low temperature of the heat transfer fluid.

An additional advantage of the apparatus is that the reservoir and associated apparatus do not necessarily need to be sized to cool a container in 10 seconds, requiring about 3,200 watts of cooling capacity, but can be fixed by the duty cycle, that is, by how many containers are cooled per minute. If the device cools one container in 10 seconds every minute, the device would need to provide about 500 watts of cooling, corresponding to about 300 watts of electricity. For cooling one container every two minutes, the device's cooling unit 404 can decrease by another factor of 2 by the use of a smaller, and more economical, compressor or similar chiller for chilling the heat transfer fluid.

As is discussed above, control and variation of can rotation can significantly enhance the internal heat transfer coefficient while preventing CO₂ nucleation for carbonated beverages. In this regard, an actuator 410 and/or motor can be provided to rotate the container and/or to move the container along its longitudinal axis during cooling.

The heat exchanger 412 can also be mounted on the inside of a deformable bladder. When the container is loaded into the heat exchanger, the bladder can deform and press the thin heat exchanger firmly against the container sidewall. Since the heat exchanger wall thickness is very thin, the heat transfer resistance through the plastic is very low. The entire bladder/heat exchanger assembly can rotate and/or move the container to reduce the internal heat transfer resistance, as is discussed above.

The heat transfer fluid is pumped through the heat exchanger 412 at moderate pressure to maintain adequate flow of the heat transfer fluid through the heat exchanger. Utilizing a heat transfer fluid having a low viscosity at low temperatures, as is discussed above, will facilitate the flow of the heat transfer fluid through the meso-scale heat exchanger under modest pressures. When a deformable bladder is utilized, the required pressurization will be low and much below typical beverage container pressurization levels. Pressurization can be accomplished with either the heat transfer fluid itself or by utilizing a separate pressurization fluid.

Since the interior sidewall of the heat exchanger physically separates the heat transfer fluid from the container surface, the container, and hence the user, advantageously never comes into direct physical contact with the heat transfer fluid. This also eliminates the need for a rinsing step after cooling of the beverage container.

The method and apparatus of the present invention can advantageously decouple the internal heat transfer (controlled by container movement) and the external heat transfer (controlled by heat transfer fluid velocity and heat exchanger gap size). Accordingly, it is possible to cool a full 12 oz. (355 ml) aluminum beverage container from a starting temperature of about 30° C. (86° F.) to less than 7° C. (44° F.) in times of not greater than about 20 seconds, more preferably not greater than about 15 seconds. In one embodiment, the full 355 ml metal beverage container is cooled from 30° C. to 7° C. in from about 10 seconds to about 20 seconds.

The method and apparatus of the present invention can advantageously obtain an average cooling rate while cooling a beverage container of at least about 1700 W (e.g., 355 ml×4.18 J/cal×(30° C.−7° C.)/20 seconds), more preferably at least about 2300 W and even more preferably at least about 3400 W.

According to one embodiment, the final temperature of the beverage container contents can be selected by the consumer. Once the user selects a desired final temperature, the apparatus can be programmed to adjust the cooling time that the heat transfer fluid is in thermal contact with the container to achieve the desired temperature. Since the temperature of the heat transfer liquid is known, the time that the container must be contacted with the heat transfer fluid can be calculated and applied. A thermocouple or similar temperature measuring device can be used to determine the starting temperature of the beverage container, if desired.

Alternatively, or in addition to, the flow rate of the heat transfer fluid can be automatically adjusted by the apparatus to control the final temperature of the container. This can be accomplished, for example, through the use of an electronically controlled variable pump to cause the heat transfer fluid to flow at a controlled rate.

The method and apparatus of the present invention can be utilized in connection with a variety of containers. The container can be a glass container or a plastic container, such as a PET beverage container. The container can also be a metallic container such as a steel or aluminum container. The containers can also have a range of sizes such as from about 90 ml to 1000 ml, more preferably from about 300 ml to about 500 ml and even more preferably from about 330 ml to about 360 ml. The container can have a variety of shapes, and in one embodiment is a cylindrical container, such as a cylindrical aluminum container.

The full beverage containers can be rapidly cooled to a temperature that is desirable for consumption. For example, a metallic container with a volume of from about 300 ml to about 360 ml (e.g., about 355 ml) can be cooled from a temperature of at least about 20° C. to less than 10° C. within about 20 seconds. For a metallic container with a volume of from about 360 ml to about 500 ml, the method and device can cool the container and its contents from a temperature of at least about 20° C. to less than 10° C. within about 40 seconds. For a glass container having a volume of from about 300 ml to about 360 ml, the method and apparatus can cool the container from a temperature of at least about 20° C. to less than 10° C. in less than about 100 seconds, and can cool a glass container having a size of from about 360 ml to about 500 ml from at least 20° C. to less than 10° C. in less than about 200 seconds.

The method and apparatus of the present invention can be utilized to provide cooling for a number of different types of beverages, including carbonated beverages (e.g., soda pop and beer) and non-carbonated beverages (e.g., juices and sports drinks), alcoholic beverages such as beer and wine, as well as beverages contained in glass bottles such as soda pop and wine. In addition, the method and apparatus can be utilized in a number of applications other than consumable liquid beverages. For example, biological specimens such as blood specimens or cell samples can be rapidly chilled to quickly preserve the specimen for storage or transport. In one embodiment, the biological specimen can be rapidly chilled within less than five minutes to quickly preserve the specimen for storage or transport.

In addition, the method and apparatus can be utilized to freeze confectionary items such as ice cream. In this regard, a liquid precursor to the ice cream can be disposed within the container. In one aspect, the ice cream container can be cooled down from a temperature of from about 6° C. to about 28° C. to less than −2° C., and preferably to less than −10° C., within about 60 seconds or less. Also, previously frozen contents within a container such as ice cream can be further chilled to hard freeze the ice cream such as for transport.

The method and apparatus of the present invention provide many advantages as compared to traditional refrigeration equipment. The amount energy required to directly cool the beverage is significantly reduced as compared to traditional vending machines where the machine must cool the beverage and keep the large vending machine storage area cold. As an example, if about 48 aluminum cans of beverage are dispensed per day from a point of use machine instead of a conventional vending machine, the amount of cooling required would only be about 22% of the amount required by the conventional vending machine. If the number of dispensed cans is lower, as in many small commercial locations, the percentage energy reduction would be even greater.

For a commercial vending application dispensing 48 containers per day and an electric cost of $0.15 per kW·Hr, the method and apparatus of the present invention could save almost $150 per year in direct energy cost. In addition to the direct energy cost, there is an additional energy cost reduction that is associated with the additional HVAC load related to vending machine waste heat rejection.

Further, with the apparatus of the present invention, a wide range of designs can be employed. The total foot-print (not counting warm beverage storage) can be as little as 5% to 15% of a conventional vending machine. This enables the use of the apparatus in many locations where a conventional vending machine is impossible or impracticable, such as on a ship, train or in a similar environment with limited space. The apparatus can also provide a means for supplying cold beverages in a situation where a large and heavy vending machine is impracticable, such as at a temporary location (e.g., a temporary carnival or festival).

The apparatus can also be adapted to simultaneously cool more than one container. For example, a larger heat transfer fluid reservoir can be provided with multiple heat exchangers or a heat exchanger adapted to hold multiple containers such that the multiple containers can be simultaneously cooled.

Unlike conventional vending or fountain dispense devices, a control function can be utilized that allows the user to select the desired temperature of the beverage. This could be accomplished by either changing the cooling time and/or the flow rate of the heat transfer fluid. In addition, for some drinks, more cooling could be input into the drink to create some ice on the interior surface and hence, a “slush” drink. Some ice can also be purposefully formed on the exterior surface of the container to maintain the cooled state of the beverage over an extended period of time.

### EXAMPLE

The following example demonstrates the use of a cooling method and apparatus to cool a 355 ml aluminum beverage can.

The apparatus includes a meso-scale heat exchanger in fluid communication with a heat transfer fluid. The meso-scale heat exchanger consists of a plastic envelope, inlet tubing and outlet tubing. The plastic envelope is held open with a biaxial mesh that forms a gap space of about 1 mm. The plastic envelope consists of a coextruded polyethylene/nylon/EVOH/nylon/polyethylene layered composite having a total thickness about 0.1 mm (available from the Cryovac Division of the Sealed Air Corporation, Duncan, S.C., USA). The inlet and outlet tubing comprises low density polyethylene tubing having 0.5″ OD and 0.375″ ID (Part No. 0525-032, Ryan Herco Products Corp., Burbank, Calif., USA). The spacer between the two sides of the plastic shell is 1 mm biaxial mesh (Part No. 15368, DelStar Technologies Inc, Middletown, Del., USA). The heat exchanger area is about 125 mm×230 mm. The heat exchanger is produced by folding a sheet of the plastic envelope with the mesh in between the two sides. The edges are heat sealed and short pieces of tubing (about 25-50 mm in length) are heat welded into each end of the envelope to produce a leak-proof heat exchanger.

The heat exchanger is wrapped around a 355 ml aluminum beverage can. Both are surrounded by a 0.003 inch thick stainless steel sheet to withstand any volume expansion during pressurization. The heat exchanger is fluidly coupled via a pump (Pump TE-MDX-MT3, available from March Mfg. Inc., Glenview, Ill., USA) to a heat transfer fluid reservoir which contains 1000 ml of silicone fluid (CAS# 141-62-8, 1.5 cSt decamethyltetrasiloxane, available from Clearco Products Co., Inc., Bensalem, Pa., USA). The heat transfer fluid is cooled down to about −40° C. by means of a Stirling Cooler (Model SC-UD08-50, Global Cooling, US, Athens, Ohio, USA). When the pump is switched on the heat transfer fluid flows through the heat exchanger and the beverage can is cooled down from 22° C. to 7° C. within 26 seconds. The starting temperature is measured using a thermocouple at the outside of the can and the final end temperature is measured inside the can after shaking and opening the can.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A method for cooling a container having an outer sidewall, comprising the steps of:
cooling a heat transfer fluid to a temperature of less than 0° C.; and
flowing the heat transfer fluid along the outer sidewall of the container to thermally contact the container and cool the contents of the container,
wherein the heat transfer fluid does not come into direct physical contact with the outer sidewall of the container during the flowing step.

2. A method as recited in claim 1, wherein said heat transfer fluid has a temperature of not greater than about −20° C.

3. A method as recited in claim 1, wherein said heat transfer fluid has a temperature of not greater than about −30° C.

4. A method as recited in claim 1, wherein said heat transfer fluid is a non-aqueous fluid.

5. A method as recited in claim 1, wherein said heat transfer fluid is a silicone-based fluid.

6. A method as recited in claim 1, wherein said flowing step comprises flowing the heat transfer fluid through a heat exchanger that is in physical contact with the outer sidewall of the container.

7. A method as recited in claim 6, wherein said heat exchanger comprises gaps through which the heat transfer fluid flows, where the gaps have a gap width of not greater than about 3 mm.

8. A method as recited in claim 1, wherein said heat transfer fluid has a viscosity of not greater than about 10 centipoise when measured at 0° C.

9. A method as recited in claim 1, wherein a liquid is disposed within said container.

10. A method as recited in claim 1, wherein a liquid beverage is disposed within said container.

11. A method as recited in claim 1, wherein said container is a metallic container.

12. A method as recited in claim 1, wherein said container is an aluminum beverage container having a beverage volume of from about 300 ml to about 500 ml, and wherein said beverage is cooled from a temperature of at least about 25° C. to less than about 7° C. in not greater than about 20 seconds.

13. A method as recited in claim 1, wherein a non-frozen liquid ice cream precursor is disposed within said container.

14. A method as recited in claim 13, wherein said non-frozen liquid ice cream precursor is cooled from a temperature in the range of from about 6° C. to about 28° C. to a temperature of not greater than about −10° C. within less than about 60 seconds.

15. A method as recited in claim 1, wherein a biological specimen is disposed within said container.

16. A method as recited in claim 1, wherein the thermal mass of the heat transfer fluid that is thermally contacted with said container during said flowing step is pre-selected based upon the thermal mass of the container and the desired final temperature of the container contents, whereby the temperature of the heat exchange fluid increases during said flowing step to avoid freezing of the liquid container contents.

17. A method as recited in claim 1, further comprising the step of agitating the container while during said flowing step.

18. A method as recited in claim 1, wherein said container is a cylindrical container.

19. A method for rapidly cooling a cylindrical metallic beverage container having a beverage disposed therein, comprising the steps of:
cooling a heat transfer fluid to a temperature of not greater than about −20° C.;
placing the beverage container within a heat exchanger such that the heat exchanger physically contacts an outer sidewall of the beverage container;
flowing the heat transfer fluid through the heat exchanger to cool the beverage to a temperature of not less than about 0° C. and not greater than about 7° C.

20. A method as recited in claim 19, wherein said flowing step lasts for not more than about 20 seconds.

21. An apparatus for the rapid cooling of a container, comprising:
a liquid reservoir adapted to contain a heat transfer fluid therein;
means for cooling the heat transfer fluid contained within the liquid reservoir to a temperature of less than 0° C.; and
a heat exchanger in fluid communication with the liquid reservoir, the heat exchanger comprising an interior sidewall and flow gaps disposed through the heat exchanger, said flow gaps having a gap width of not greater than about 10 mm, wherein the flow gaps are in fluid communication with the liquid reservoir and wherein the interior sidewall is adapted to conform around the container when the container is placed in the device.

22. An apparatus as recited in claim 21, wherein said heat exchanger interior sidewall has a thickness of not greater than about 200 μm.

23. An apparatus as recited in claim 21, wherein said cooling means comprises a Stirling cooler.

24. An apparatus as recited in claim 21, wherein said cooling means is adapted to cool the heat transfer fluid to a temperature of not greater than about −20° C.

25. An apparatus as recited in claim 21, wherein said reservoir is adapted to contain not more than about 2 liters of the heat transfer fluid.

26. An apparatus as recited in claim 21, wherein said heat exchanger has a thermal mass that is not greater than 20% of the thermal mass of a full 355 ml aluminum beverage container.

27. An apparatus as recited in claim 21, wherein said heat exchanger is a plastic heat exchanger.

28. An apparatus as recited in claim 21, further comprising a pump for flowing the heat transfer fluid through said heat exchanger flow gaps.

29. An apparatus as recited in claim 21, further comprising means for agitating the container when the container is placed within the device.

30. An apparatus as recited in claim 21, wherein said flow gaps have a gap width of at least about 0.5 mm and not greater than about 3 mm.
